(19) United States
(12) Patent Application Publication
(10) Pub. No.: US 2007/0133850 A1
(43) Pub. Date: Jun. 14, 2007

(54) System for making a medical device

(75) Inventor: Juan B. Paez, Rockaway, NJ (US)

Correspondence Address: HARNESS, DICKEY & PIERCE, P.L.C., P.O. BOX 828, BLOOMFIELD HILLS, MI, 48303, US

(73) Assignee: EBI, L.P., Parsippany, NJ (US)

(21) Appl. No.: 11/297,769

(22) Filed: Dec. 8, 2005

(51) Int. Cl. G06K 9/00

(52) U.S. Cl. 382/128

(57) ABSTRACT

A castless system and method for sizing a medical device for use with limbs, joints, appendages, and other body members of a human or animal subject. The system uses at least two digital images to create a body member profile and extract measurements for the selection of a model template. The model template is used to manufacture a custom made orthosis, such as a brace.

### FIELD

The present disclosure relates to a biomechanical measurement system for sizing a medical device.

### INTRODUCTION

Numerous conventional measurement systems exist for the sizing of three-dimensional objects, including complex systems for sizing limbs, joints, and appendages of a human or animal subject. Various casting systems have been used in the past with relatively high accuracy and success; however, casting of body members is a time consuming process. The manufacture and shipping of custom made casts increases the costs dramatically. In situations where time is of the essence, casting systems are often not the most feasible method.

Various other technologies are currently available using laser devices or multiple camera systems where several images are correlated with one another to determine three-dimensional sizes and shapes. The systems typically require the use of complex booths, equipment setups, calibration mechanisms, scanners, lighting fixtures, and other equipment. The development of a compact, economic, portable, and accurate image based measurement system would satisfy a long felt need for the ability of using a large number of such system components in the field, where body member injuries are in need of a custom made medical device, such as an orthosis, for treatment.

### SUMMARY

In accordance with the teachings of the present disclosure, a method of using biomechanical measurements for the sizing of limbs, joints, appendages, and other body members of a human or animal subject is provided. In various embodiments, the methods comprise orienting a body member adjacent a measurement fixture and obtaining at least two digital images of the body member. The digital images are processed and measurement parameters are subsequently extracted. The measurement parameters are compared with pre-existing model template data stored in a model template database and a plurality of suitable matching model templates are provided to a user based on the comparison. The user selects a suitable model template for the body member and coordinates necessary adjustments to the selected model template based on the extracted measurement parameters. The model template can be used to manufacture a custom made orthosis or body member brace.

In another aspect, the teachings of the present disclosure provide a method for sizing a medical device for use with limbs, joints, appendages, and other body members of a human or animal subject. The method comprises using a hand-held camera and obtaining at least two digital images of a body member. At least one physical measurement of the body member is obtained and the digital images and at least one physical measurement are transmitted to a remote processing system. The digital images are processed and measurement parameters are extracted. The measurement parameters are compared with pre-existing model template data stored in a model template database and the processing system provides a plurality of suitable model template matches based on the comparison. A suitable model template is selected and any necessary sizing adjustments are provided. The model template is then used to manufacture a custom made orthosis or medical device for the body member.

In still another aspect, the teachings of the present disclosure provide a system for using biomechanical measurements for the sizing of limbs, joints, appendages, and other body members of a human or animal subject. The system comprises at least two digital images of a body member and a processing system. The processing system is configured to receive the digital images and extract measurement parameters of a body member profile. In various embodiments, the system performs a comparison of the measurement parameters with pre-existing model template data stored in a model template database. The system selects at least one suitable model template for the body member based on the comparison and provides the model template to a manufacturing system to create a custom made orthosis. In yet another aspect, the teachings of the present disclosure provide a system comprising a mobile kit including a camera and a transmission device for remotely taking and transmitting digital images of a body member to the processing location.

Further areas of applicability of the present disclosure will become apparent from the detailed description provided hereinafter. It should be understood that the detailed description and specific examples, while indicating various embodiments of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a flow diagram of a method of creating a custom made orthosis for a body member according to the principles of the present disclosure.

### DESCRIPTION OF VARIOUS EMBODIMENTS

The following description of the various embodiments is merely exemplary in nature and is in no way intended to limit the disclosure, its application, or uses.

In various embodiments, the present teachings disclose the biomechanical sizing of a human or animal subject, and more particularly, the sizing of human joints, limbs, appendages, and other body parts. The disclosed embodiments are particularly advantageous in measuring parts of the human body with a goal towards obtaining an accurate representation of a full or partial area or region of the body that is to be sized or measured. Such an accurate representation is especially useful for creating suitably sized and configured medical devices, such as joint braces, and more specifically, knee and elbow braces. In the case of joint braces, substantial care is typically needed to provide accurate measurements for a correctly sized medical device.

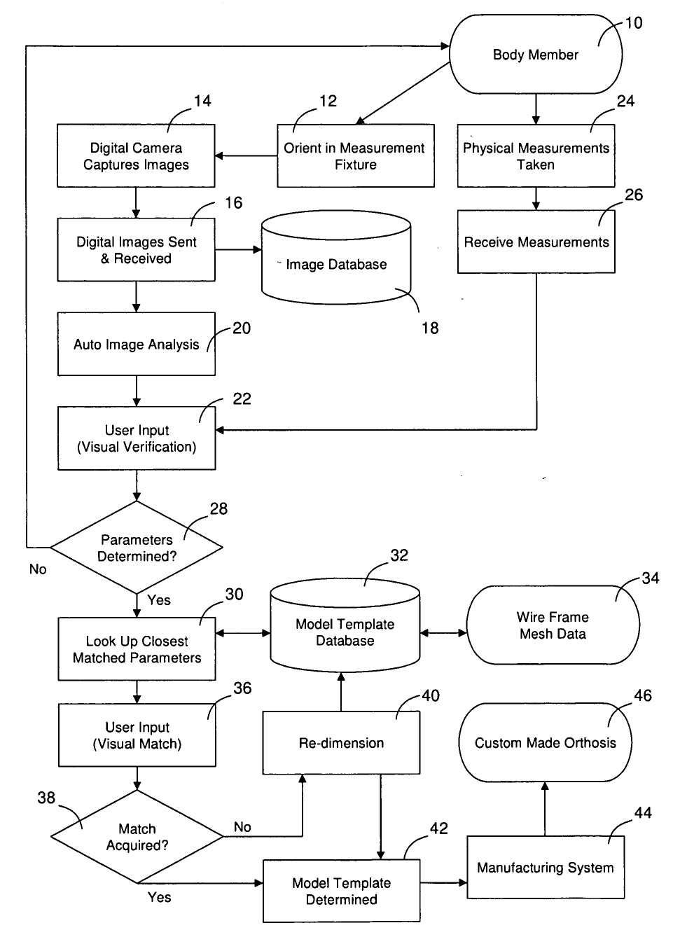

FIG. 1 depicts a flow diagram illustrating an overview of a system and method of creating a custom made orthosis, or medical device, for a body member according to the principles of the present disclosure. As a brief synopsis, the illustrated embodiments use an automated analysis of digital images to extract measurement parameters that are used to select a pre-existing model template. The model template is re-dimensioned and customized to the specific body member if necessary, and can be used to manufacture a custom made orthosis, such as a brace. As should be understood, FIG. 1 illustrates various embodiments of the present teachings and certain of the method boxes illustrate optional steps or processes. It should further be understood that while separate boxes are illustrated as being separate steps, various embodiments will combine steps or processes, and the combination or omission of certain features, including changing the order of the illustrated steps, are within the scope of the present disclosure.

The process generally begins with selecting a body member, as referenced by method box 10 of FIG. 1. In various embodiments, the body member is oriented in or adjacent to a portable measurement fixture as referenced by method box 12. The measurement fixture can be of numerous designs, such as a planar or generally “L” shaped acrylic board member, and generally provides a background with at least one type of reference standard so that accurate measurements can be obtained. In various embodiments, the reference standard includes a known scale and is configured to readily provide accurate dimensional information. Non-limiting examples of suitable reference standards include a background target or landmark, a measuring tape, a ruler, a grid pattern, a checkered pattern, or combinations thereof. In other embodiments, the reference standard may also be a form-fitting and/or uniquely colored garment that more or less serves to provide a contrast or silhouette for determining the edges and/or contours of the body member. In certain instances, the measurement fixture may include the use of both a reference standard and a form-fitting and/or uniquely colored garment, as described above. In other embodiments, a form-fitting garment may be used having an identifying reference standard thereon. In this instance, orienting the body member adjacent a measurement fixture would comprise placing the body member in the form-fitting garment. U.S. Pat. No. 5,911,126 to Massen, issued on Jun. 8, 1999, and U.S. Pat. No. 6,549,639 to Genest, issued Apr. 15, 2003 provide examples and descriptions of various garments, reference standards, and related methods of sizing and are incorporated herein by reference in their entirety.

In various embodiments, at least two digital images of the body member are remotely obtained in the field as referenced by method box 14, commonly in a portrait format, and are in many instances electronically transmitted to a processing location. In many embodiments, the image views include at least one generally anterior image and at least one generally lateral image of the particular body member in need of a medical device. It should be understood that in many instances only one or two digital images will be necessary, however, additional images may be taken and provided if the body member, for example, has complex features. In many instances, the user of the camera will be instructed to capture the images at a predetermined distance from the body member, and most likely at a predetermined angle, position, and/or height in relation to the body member. This generally provides uniformity of the images and may alleviate any need for using a tripod. It also allows for increased sizing accuracy. Any number of camera types may be used. Non-limiting examples of cameras range from professional hand-held digital cameras to cellular telephones configured with an image capturing device. In certain embodiments, as will be discussed in more detail, cellular phone or PDA type cameras offer many advantages.

As should be understood, in certain instances, it may not be feasible to obtain digital images of the body member in the field. In this case, non-digital images, such as conventional photographs, may be obtained and converted into a digital format using scanning or processing techniques as are widely known in the art.

In various embodiments, the digital images can have a resolution of VGA quality (640×480 pixels) or better. Generally, VGA quality provides an accuracy with 1 pixel being approximately equal to about 0.03 inches for a body member encompassed in a 16″ by 5″ framed area. This would allow for the extraction of measurement data from the images having an accuracy of about 1/16 of an inch. As should be understood by those skilled in the art, as the resolution is increased, so is the accuracy of the extracted of measurement data. For example, an image taken at a resolution of about 3.0 megapixels (2,000×1,500 pixels) provides an accuracy with 1 pixel being approximately equal to about 0.01 inches. The increase in resolution would generally allow for the extraction of measurement data from the images having an accuracy of about 1/32 of an inch, or better. Of course images having greater resolution can also be used, but it has been found that for a custom knee brace, the VGA resolution can provide sufficient accuracy.

Various embodiments of the present disclosure provide a mobile kit to be used out in the field and/or carried by medical sales professionals or medical technicians. In various embodiments, the mobile kit can include some type of transportable image capturing device, such as a hand-held camera, in addition to a transmission device for electronically transmitting digital images and/or further measurement data to a remote processing system. In various embodiments the mobile kit includes a measurement fixture along with a cellular telephone equipped with an image capturing device. Cellular telephones are typically configured to additionally remotely send electronic media, including images, e-mails, and similar data. Such cellular telephones having an image capturing device in addition to transmission capabilities may be chosen for use with the present disclosure. It should be understood that various other transmission means can also be used to remotely send data to the processing system, including notebook computers or personal digital assistants (PDA) using wired or wireless internet technology. In various embodiments, the transmission of data can be carried out using the internet, both wired and wireless; using a land based phone with a direct data link; using a cellular phone; using a direct hard wire link; and the like. The mobile kit may also include conventional type measuring devices, such as rulers, measuring tapes, calipers, and similar tools.

In many embodiments, a field technician obtains at least one physical measurement of the body member before or after taking the digital images as referenced by method boxes 24 and 26. In certain embodiments, the measurements correspond to at least one length or circumference measurement relative to a center area of the body member. It may be desired, for example, to obtain a plurality of spaced apart measurements at predetermined locations, depending on the body member being measured. As a non-limiting example, if the medical device is a knee or elbow brace, it may be beneficial to obtain measurement parameters that correspond to an anterior-posterior (AP) dimension, a transepicondylar (ML) dimension, or both.

In various embodiments, the measurements may include three or less circumference measurements, while it should be understood that it may be beneficial to provide further measurements for body members having a more complex shape. As a non-limiting example, the measurements may include a circumference of the center of a body member, such as an elbow or knee (i.e., the patella) and the circumference at a predetermined distance in one or both directions away from the center point, for example from about 2 to about 10 inches from one or both directions, and in certain embodiments from about 3.5 to about 8 inches, or from about 5 to about 7 inches in one or both directions. In certain embodiments, using a knee as an example, the location of the patella can be determined from an anterior view of the knee area and the patella can be used as a landmark, or reference point marked in the field as the center point region. It should be understood that the distance from the center point will vary depending upon the body part being fitted for a medical device, and the variations are within the scope of the present disclosure.

In various embodiments, the physical measurements are remotely transferred to the processing system similar to the digital images, as previously discussed. The images and measurement data and/or parameters may be sent to the processing system as one or separate data files, sequentially, or they may be sent together simultaneously. In various embodiments, the measurement data can be entered into a phone, laptop, or an equivalent portable device in the field and subsequently transferred to a central database or processing system. In other embodiments, the measurement data may be entered into an electronic form on a website and the digital images may be uploaded to the website from practically any location having internet access. Any transfer can also be accomplished via a direct device to device, wired or wireless connection.

As used herein, the terms “measurement data” and “measurement parameter” refer to key parameters that are typically necessary in order to create a body member profile for use with a custom made orthosis, such as a knee brace. Certain measurement parameters may include the physical measurements taken by a field technician. Non-limiting measurement parameters include dimensions such as AP and ML, and the location of the center point of the body member and other spaced apart parameters, such as circumference measurements as previously described. Other parameters can be extracted by using the digital images incorporating the measurement fixture and reference standard. For example, it may be quite useful to note the angle of the camera in relation to the body member as different perspectives may yield different sizes. Thus, in certain embodiments, in particular where the reference standard comprises a checkerboard-like pattern, the angle at which the image was taken can be determined and the data may be altered if necessary. A checker-board type pattern may further allow easy detection of a center point if not marked in the field. In still other embodiments, the measurement parameters, or the body member profile may contain wireframe mesh data.

Wireframe mesh data is commonly used to create a model or a visual presentation of an electronic representation of a three dimensional object. For example, wireframe mesh data is commonly used in 3D computer graphics. It is created by specifying each edge of the physical object where two mathematically continuous smooth surfaces meet, or by connecting an object's constituent vertices using straight lines or curves. The object is projected onto a computer screen by drawing lines at the location of each edge. Using a wireframe model allows visualization of the underlying design structure of a 3D model. Traditional 2-dimensional views and drawings can be created by appropriate rotation of the object and selection of hidden line removal via cutting planes.

Since wireframe renderings are relatively simple and fast to calculate, they are often used in cases where a high screen frame rate is needed (for instance, when working with a particularly complex 3D model, or in real-time systems that model exterior phenomena). When greater graphical detail is desired, surface textures can be added automatically after completion of the initial rendering of the wireframe. This allows a designer to quickly review changes or rotate the object to new desired views without long delays associated with more realistic rendering.

Once the digital images are sent to the processing system as referenced by method box 16, the digital data is processed and measurement parameters are extracted using an automated image analysis as is known in the art and referenced by method box 20. In various embodiments, the images are stored in a database as referenced by method box 18. In certain embodiments, the processing system performs an automatic parameterization of the images and data to create a body member profile. As a non-limiting example, the two (or more) digital images may be transformed into cross-sectional, 2-dimensional images that define an outline of the body member.

In many embodiments, the image analysis portion of the processing system will include a system user that may visually examine the digital images and verify the extracted measurement parameters are correct as referenced by method box 22. If the measurement parameters are not automatically determined as referenced by decision box 28, the user may need to examine the reference standard in the digital image and/or make any adjustments or calibrations as may be necessary, such as cropping, rotating, centering or otherwise altering and adjusting the images. The user may need to refer to the data parameters and/or physical measurements obtained in the field to confirm or verify the parameters. The user can also enter patient information into a database at this point in time, which may include such information as a name, a work order number, any physical measurement that was taken in the field, and any other relevant information. Alternatively, this information can be included in the information transmitted to the system from the mobile kit.

Once the parameters are in fact determined as referenced by a positive decision from reference box 28, the processing system will perform a comparison of the measurement parameters with pre-existing model template data as referenced by method box 30. In various embodiments, the model template data is stored in a model template database, as referenced by box 32, which may contain a vast amount of data including key measurement parameters and wireframe mesh data, as referenced by method box 34, for all of the existing templates. In various embodiments, the measurement parameter comparison includes user intervention, such as allowing a user to configure search criteria and/or examine or verify potential template matches. In some embodiments, the processing system is configured to provide a plurality of suitable matching model templates to a user based on the comparison and searches. In various embodiments, the database or processing system provides a display of matching thumbnail results for a user to select the best visual match. Depending on the amount of data and templates in the model template database, a pre-existing model template may be a suitable match “as-is” and without any changes.

In various other embodiments, the processing system is configured to solicit input from a user as referenced by method box 36, and the user will select the most suitable model template and coordinate necessary adjustments to the selected model template based on the extracted measurement parameters, various visual indications and/or physical measurements taken in the field. As referenced in decision box 38, if a match is not obtained, or if too many results are shown, the user can reconfigure the search criteria and repeat the search or the closest match can be selected for re-dimensioning as indicated by method box 40. In various embodiments, the database is equipped with configuration tools to allow fine tuning and adjustments of the search criteria. The re-dimensioning process may need to be performed only once, or alternatively, it may be an iterative process depending on the particular body member profile needed. Once a suitable model template is selected as referenced by method box 42, a new patient template will be created and configured to dimensionally match the actual patient and their specific body member profile. In various embodiments, this new patient template is saved and imported into the model template database as a new template for future use.

In various embodiments, the suitable model template is provided for use with a manufacturing system as referenced by method box 44 and is used to create a custom made orthosis as referenced by method box 46. In certain embodiments, the processing system that extracts measurement parameters and provides the model template is incorporated within the manufacturing system, such that the processing system and the manufacturing system are one in the same.

In various embodiments, the manufacturing system is similar to a typical manufacturing system used to create medical devices such as a custom made orthosis. Once the data is obtained and received, and a model template is chosen, wireframe mesh data is rendered using appropriate software and modifications are made to create a tool pack for a carving machine. Typically the carving machine will create a foam body member representative of the key dimensions and measurements of the patient. The foam body member is then used to create a custom made orthosis such as a knee brace.

The description of the disclosure is merely exemplary in nature and, thus, variations that do not depart from the gist of the disclosure are intended to be within the scope of the claims. Such variations are not to be regarded as a departure from the spirit and scope of the disclosure.

What is claimed is:

1. A method of using biomechanical measurements for the sizing of limbs, joints, appendages, and other body members of a human or animal subject, the method comprising:
orienting a body member adjacent a measurement fixture;
obtaining at least two digital images of the body member;
processing the digital images and extracting measurement parameters;
comparing the measurement parameters with pre-existing model template data stored in a model template database; and
providing a plurality of suitable matching model templates to a user based on the comparison,
wherein the user selects a suitable model template for the body member and coordinates necessary adjustments to the selected model template based on the extracted measurement parameters.

2. A method according to claim 1, further comprising obtaining at least one data parameter corresponding to a physical measurement of the body member, wherein the at least one data parameter is used to verify the measurement parameters.

3. A method according to claim 1, comprising obtaining the at least two digital images using a hand-held camera.

4. A method according to claim 3, comprising remotely obtaining the images and electronically transmitting the images to a processing location.

5. A method according to claim 1, further comprising re-dimensioning the selected model template and configuring a new model template to generally match the measurement parameters of the body member.

6. A method according to claim 5, wherein re-dimensioning the model template comprises user input.

7. A method according to claim 5, further comprising importing the new model template into the model template database as a new template for future use.

8. A method according to claim 1, further comprising using the selected model template to manufacture a custom made orthosis.

9. A method according to claim 1, wherein extracting the measurement parameters comprises user input.

10. A method according to claim 9, wherein the user selects the suitable model template from the plurality of matches based on a visual verification.

11. A method according to claim 1, wherein obtaining digital images comprises obtaining non-digital images and processing the digital images comprises converting the non-digital images into a digital format.

12. A method according to claim 1, wherein obtaining digital images comprises obtaining at least one anterior image and at least one lateral image of the body member.

13. A method according to claim 1, wherein the measurement fixture comprises a reference standard having a known scale and configured to provide dimensional information.

14. A method according to claim 13, wherein the reference standard is selected from the group consisting of: a measuring tape, a ruler, a grid pattern, a checkerboard pattern, a colored garment, a form-fitting garment, or combinations thereof.

15. A method according to claim 13, wherein orienting the body member adjacent a measurement fixture comprises placing the body member in a form fitting garment having an identifying reference standard thereon.

16. A method according to claim 1, wherein extracting measurement parameters comprises obtaining at least one data parameter corresponding to one of an anterior-posterior (AP) dimension, a transepicondylar (ML) dimension, or both.

17. A method according to claim 1, wherein the body member comprises a knee joint.

18. A method according to claim 17, further comprising obtaining at least one data parameter corresponding to at least one circumference measurement relative to a center area of the knee joint.

19. A system for using biomechanical measurements for the sizing of limbs, joints, appendages, and other body members of a human or animal subject, the system comprising:
at least two digital images of a body member; and
a processing system configured to receive the digital images and extract measurement parameters of a body member profile, wherein the system performs a comparison of the measurement parameters with pre-existing model template data stored in a model template database and selects at least one suitable model template for the body member based on the comparison, the system further provides the at least one model template to a manufacturing system to create a custom made orthosis.

20. A system according to claim 19, further comprising at least one data parameter corresponding to a physical measurement of the body member, wherein the at least one data parameter is used to verify the measurement parameters.

21. A system according to claim 20, wherein the processing system receives the digital images and at least one data parameter from a remote location.

22. A system according to claim 19, wherein the processing system is configured to solicit input from a user during the selection of the at least one suitable model template.

23. A system according to claim 19, wherein the processing system re-dimensions the at least one suitable model template and creates a new model template to generally match the parameters of the body member profile.

24. A system according to claim 23, wherein the processing system imports the new model template into the model template database as a new template for future use.

25. A system according to claim 19, wherein the model template database comprises wireframe mesh data.

26. A system according to claim 19, wherein the at least two digital images incorporate a reference standard having a known scale and configured to provide dimensional information.

27. A system according to claim 26, further comprising a measurement fixture having the reference standard, wherein at least one of the digital images incorporates the measurement fixture therein.

28. A system according to claim 19, wherein the processing system and the manufacturing system are the same.

29. A system according to claim 19, further comprising a mobile kit comprising a hand-held camera and a transmission device for remotely transmitting digital images to the processing system.

30. A system according to claim 29, wherein the mobile kit comprises a cellular telephone equipped with an image capturing device.

31. A system of using biomechanical measurements for the sizing of limbs, joints, appendages, and other body members of a human or animal subject, the system comprising:
a mobile kit comprising a camera and a transmission device for transmitting digital images of a body member to a processing location; and
a processing system configured to receive at least two digital images from the mobile kit and create a body member profile, wherein the system performs a comparison of the body member profile with pre-existing model template data stored in a model template database and provides at least one suitable model template to generally match the body member profile based on the comparison.

32. A system according to claim 31, wherein the system further comprises using the model template to manufacture a custom made orthosis.

33. A system according to claim 31, wherein the mobile kit comprises a cellular telephone equipped with an image capturing device, the telephone being configured to remotely send data to the processing system.

34. A system according to claim 31, wherein the mobile kit further comprises a measurement fixture configured to provide dimensional information, wherein at least one of digital images incorporates the measurement fixture therein.

35. A system according to claim 34, wherein the measurement fixture comprises a reference standard selected from the group consisting of: a measuring tape, a ruler, a grid pattern, a checkerboard pattern, a colored garment, a form-fitting garment, or combinations thereof.

36. A system according to claim 31, wherein the processing system provides a plurality of suitable model templates to a user, further wherein the user selects a model template based on a visual verification.

37. A system according to claim 31, wherein the body member profile comprises at least one measurement parameter.

38. A system according to claim 31, wherein the body member profile comprises wireframe mesh data.

39. A method for sizing a medical device for use with limbs, joints, appendages, and other body members of a human or animal subject, the method comprising:
using a hand-held camera and obtaining at least two digital images of a body member;
obtaining at least one physical measurement of the body member;
transmitting the at least two digital images and at least one physical measurement to a remote processing system;
processing the digital images and extracting measurement parameters;
comparing the measurement parameters with pre-existing model template data stored in a model template database;
selecting at least one suitable model template and providing necessary sizing adjustments; and
using the model template to manufacture a custom made orthosis.

40. A method according to claim 39, wherein selecting at least one suitable model template comprises providing a plurality of suitable model template matches based on the comparison and selecting a model template based on a visual comparison.

41. A method according to claim 39, further comprising orienting the body member adjacent a measurement fixture having a reference standard prior to obtaining the digital images.

42. A method according to claim 39, further comprising verifying the accuracy of the measurement parameters using the at least one physical measurement prior to comparing the measurement parameters with pre-existing model template data.

43. A method according to claim 39, wherein the orthosis comprises a knee brace.

44. A method according to claim 43, wherein the at least one physical measurement corresponds to at least one circumference measurement relative to a center area of a knee joint.

45. A method according to claim 39, wherein at least one measurement parameter corresponds to one of an anterior-posterior (AP) dimension, a transepicondylar (ML) dimension, or both.
